(19) United States
(12) Patent Application Publication
(10) Pub. No.: US 2026/0190022 A1
(43) Pub. Date: Jul. 2, 2026

(54) DISCOVERY SIGNAL

(71) Applicant: Telefonaktiebolaget LM Ericsson (PUBL), Stockholm (SE)

(72) Inventors: Sina Maleki, MALMÖ (SE); Ali Nader, MALMÖ (SE); Pål Frenger, LINKÖPING (SE); Andres Reial, HÖLLVIKEN (SE); Ajit Nimbalker, DUBLIN, CA (US)

(21) Appl. No.: 19/126,101

(22) PCT Filed: Nov. 3, 2023
(86) PCT No.: PCT/SE2023/051120

§ 371 Date: Apr. 30, 2025

Related U.S. Application Data
(60) Provisional application No. 63/422,520, filed on Nov. 4, 2022.

(51) Int. Cl. H04W 52/02; H04W 48/16

(52) U.S. Cl. CPC H04W 52/0206; H04W 48/16

(57) ABSTRACT

A wireless communication device receives a discovery signal from a first cell. The wireless communication device receives a synchronization signal block, SSB, and/or a master information block, MIB, and/or a system information block 1, SIB1, from a second cell. According to some embodiments, the discovery signal indicates the second cell from which the wireless communication device can receive the SSB, and/or MIB, and/or SIB1. According to some embodiments, the discovery signal comprises an identifier, and the wireless communication device uses the identifier to verify validity of the SSB and/or MIB and/or SIB1 received from the second cell.

### TECHNICAL FIELD

The present disclosure generally relates to wireless communication, and in particular to a discovery signal for assisting wireless communication devices to obtain system information.

### BACKGROUND

### Network (NW) Energy Consumption

NW energy consumption in new radio (NR) increases with respect to long term evolution (LTE) due to more complex hardware (HW), e.g., higher bandwidth (BW) and a greater number of antennas. This is particularly more evident when the NW operates in higher frequencies. Hence it is important for the NW to turn ON/OFF unused HW modules during inactivity times. For example, in frequency range 2 (FR2), an NR base station (gNB) can be configured with up to 64 beams and transmit up to 64 synchronization signal blocks (SSBs). This implies 64 ports with many transceiver chains involved. Such SSBs are transmitted every 20 ms in during 5 ms windows for the sake of providing coverage to potential user equipments (UEs) even if there actually are no UEs present in the cell. Another example of energy costly always-on broadcast transmissions is system information block 1 (SIB1) which is typically transmitted (per beam) every 20/40 ms.

### SSB and SIB1 Configurations

An NR gNB can be configured with up to 64 SSBs. The configured SSBs in a cell for UEs in radio resource control (RRC) IDLE/INACTIVE have all the same periodicity and output power. The gNB can provide information to the UEs about how many/which SSBs that are active (present) within the serving cell and neighboring cells. The SSB consists of a primary synchronization signal (PSS), a secondary synchronization signal (SSS) and the physical broadcast channel (PBCH).

The gNB can further provide information about the rate/periodicity at which these SSBs are provided on cell level. For the serving cell, the parameter ssb-PositionsInBurst indicates which of the SSBs that are active, and the parameter ssb-PeriodicityServingCell specifies the rate/periodicity of them. Furthermore, the UEs are informed about the SSBs output power via the common parameter ss-PBCH-BlockPower. When it comes to neighbor cells, a gNB can specify the neighboring active (present) SSBs via the parameter ssb-ToMeasure and the associated rate/periodicity via the SSB Measurement Timing Configuration (SMTC) which defines the time window during which the UE measures the SSBs belonging to these neighboring cells. The UE makes certain assumptions for a standalone NR cell upon the cell selection procedure. Even though the periodicity of the SSB is configurable, the UE upon initial cell selection expects that the SSB is provided every 20 ms in that cell. Furthermore, the UE expects that SIB1 is transmitted in every beam (corresponding to every SSB) of the cell. For example, for a 64-beams/SSB configuration, the UE expects that SIB1 is broadcast/swept in 64 beams. The transmission period of SIB1 is typically between 20 ms and 40 ms (for example, 64 instances of SIB1 may be transmitted by the gNB every 20 ms). The master information block (MIB) is part of the SSB. Together with SIB1 they are called Minimum System Information (Minimum SI). If the UE cannot determine the full contents of the minimum SI of a cell by receiving from that cell, the UE considers that cell as barred. Other system information (OSI) (i.e., SIBs 2, 3, . . . carried in SI containers) is also broadcast in a similar manner per beam. However, for the serving cell, the gNB may choose to not constantly transmit SI and either transmit these in dedicated messages to the UEs when in connected mode or let the UEs ask for SI provision on demand. Depending on the gNB's configuration, the on-demand request from UE may either be done through random access specific resources or higher layer signaling. Regardless, UEs are informed via SIB1 that the current cell is broadcasting or can broadcast SI on-demand (see for example 3GPP TS 38.331 v17.1.0, SchedulingInfo→si-BroadcastStatus→ENUMERATED{broadcasting, notBroadcasting}).

UEs are configured with the above SSB/SIB1/SI presence and timing/rate information either in RRC_IDLE/INACTIVE via broadcast system information or in RRC_Connected via dedicated RRC messages. In IDLE/INACTIVE, the ssb-PositionsInBurst and ssb-PeriodicityServing for a serving cell is configured via SIB1, and the SMTC configurations for neighboring cells are provided in SIB2/SIB4 contained in SI messages.

For the sake of energy savings, there are discussions in a 3GPP Rel-18 study item on NW energy efficiency about having cells that do not transmit SSBs or SIB1/SI. Instead, there is a coverage/overlapping cell that broadcasts SIB1/SI for the underlying cells and the UEs may acquire the information from the coverage cell instead.

### Master Information Block (MIB)

The MIB is transmitted as a message part of the PBCH, which is a part of the SSB, and it contains the following information (see for example 3GPP TS 38.331 v17.1.0):

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

In addition to the MIB content, the SSB also provides the UE with a physical cell identity (ID) (derived from the sequence indices of the PSS and SSS) and an SSB-Index (derived from the sequence index of the DM-RS transmitted in the PBCH). As shown in FIG. 1, a normal SSB (as specified for example in NR Release 15) extends across 4 symbols in the time domain (in the horizontal direction in FIG. 1) and extends across 20 physical resource blocks (PRBs) in the frequency domain (in the vertical direction in FIG. 1). The PSS extends across 127 subcarriers (SC). Up to L SSBs may be transmitted in 5 ms. 20 ms SSB periodicity may be used for initial access.

### Challenges

There currently exist certain challenge(s). In the 3GPP Rel-18 NW energy efficiency study item, the idea of a lightweight SSB or SSB-alike signal, which may for example be referred to as a Discovery Reference Signal (DRS), is mentioned as a technique such that the NW can save power, e.g., by transmitting a lower number of symbols than a normal SSB. Nevertheless, the detailed design of a such a DRS is not disclosed, and additionally it is not clear how a UE can distinguish a DRS from a normal SSB, or what information or reference signals are contained in a DRS. Therefore, there is a need for a more detailed design of such a DRS.

One way to use the DRS is to transmit a DRS when the cell is in idle or deactivated mode. The UE can then receive the DRS and attempt to wake-up the cell, for example by transmitting a wake-up signal (WUS) in response to the DRS. For example, the patent application publication EP3313010A1 discloses that a wireless device detects a discontinuous transmission (DTX) cell that operates in a DTX state by receiving a discovery signal from the DTX cell, and transmits an initial request message to the DTX cell to request the DTX cell to transmission from the DTX state to a continuous transmission (TX) state.

### SUMMARY

A first aspect provides embodiments of a method performed by a wireless communication device. The method comprises receiving a discovery signal from a first cell, and receiving a synchronization signal block (SSB) and/or a master information block (MIB) and/or a system information block 1 (SIB1) from a second cell. According to some embodiments, the discovery signal indicates the second cell from which the wireless communication device can receive the SSB, and/or MIB, and/or SIB1. According to some embodiments, the discovery signal comprises an identifier, and the method further comprises using the identifier to verify validity of the SSB and/or MIB and/or SIB1 received from the second cell.

Corresponding embodiments of a wireless communication device are also provided.

A second aspect provides embodiments of a method performed by a network node. The method comprises transmitting a discovery signal in a first cell. According to some embodiments, the discovery signal indicates a second cell from which a wireless communication device can receive a synchronization signal block, SSB, and/or a master information block, MIB, and/or a system information block 1, SIB1. According to some embodiments, the discovery signal comprises an identifier for verifying validity of a SSB and/or MIB and/or SIB1 received from a second cell.

Corresponding embodiments of a network node are also provided.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 shows an SSB extending across 4 symbols in the time domain across 20 PRBs in the frequency domain;

FIG. 2 shows a flow chart of a method performed by a wireless communication device, according to some embodiments;

FIG. 3 shows a flow chart of a method performed by a network node, according to some embodiments;

FIG. 4 shows an example of a communication system in accordance with some embodiments;

FIG. 5 shows a UE in accordance with some embodiments;

FIG. 6 shows a network node in accordance with some embodiments;

FIG. 7 is a block diagram of a host in accordance with some embodiments;

FIG. 8 is a block diagram illustrating a virtualization environment in which functions implemented by some embodiments may be virtualized; and

FIG. 9 shows a communication diagram of a host communicating via a network node with a UE over a partially wireless connection in accordance with some embodiments.

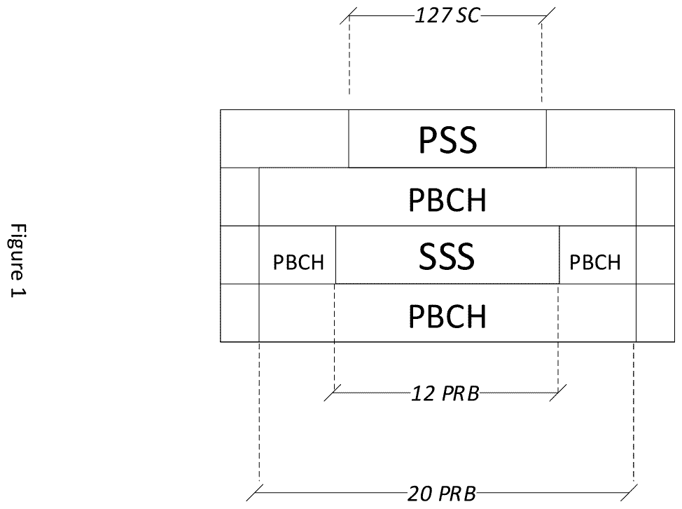

### DETAILED DESCRIPTION

Some of the embodiments contemplated herein will now be described more fully with reference to the accompanying drawings. Embodiments are provided by way of example to convey the scope of the subject matter to those skilled in the art. Certain aspects of the disclosure and their embodiments may provide solutions to these or other challenges. A new SSB-alike discovery reference signal (DRS), including its characteristics, is described herein. Particularly, herein, is addressed the lightweight SSB or DRS design for the case where the cell is in idle or deactivated mode as a whole, or in one or more beams. Then a UE can discover the lightweight SSB or DRS, and try to wake-up the cell or specific beams, for example by transmitting a WUS. Also described herein is a modified or enhanced master information block (MIB) that can indicate one or more of new fields, such as uplink WUS configuration/resources, etc.

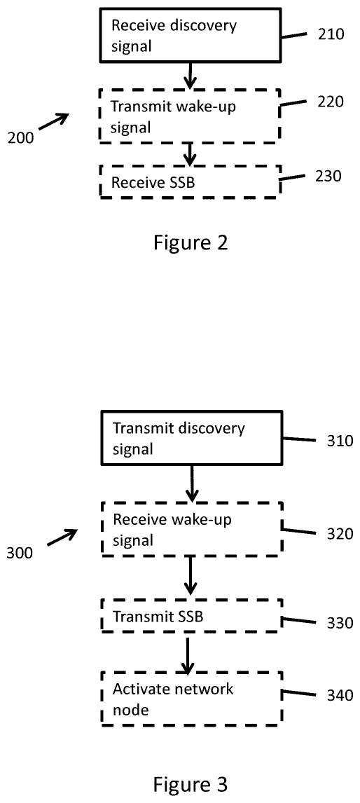

Embodiments of a method performed by a wireless communication device (for example a UE) will now be described. FIG. 2 illustrates an example flow chart of such a method 200.

According to some embodiments, the method 200 comprises receiving 210 a discovery signal. The discovery signal may for example be the discovery reference signal (DRS) referred to throughout the present disclosure. The discovery signal may for example occupy less time and/or frequency resources than a synchronization signal bock (SSB) specified in NR Release 15.

According to some embodiments, the method 200 further comprises: responsive to receiving the discovery signal, transmitting 220 a wake-up signal. According to some embodiments, the method 200 further comprises receiving 230 a synchronization signal block (SSB) after transmitting the wake-up signal.

Further embodiments of the method 200 are provided throughout the present disclosure, for example in the section entitled “Group A Embodiments”.

Embodiments of a method performed by a network node (for example a radio network node, such as a gNB) will now be described. FIG. 3 illustrates an example flow chart of such a method 300.

According to some embodiments, the method 300 comprises transmitting 310 a discovery signal. The discovery signal may for example be the discovery reference signal (DRS) referred to throughout the present disclosure. The discovery signal may for example occupy less time and/or frequency resources than a synchronization signal bock (SSB) specified in NR Release 15.

According to some embodiments, the method 300 further comprises receiving 320 a wake-up signal after transmitting the discovery signal. According to some embodiments, the method 300 further comprises: responsive to receiving the wake-up signal, transmitting 330 a synchronization signal block (SSB). According to some embodiments, the discovery signal is transmitted 310 while the network node is in a power saving mode (which may for example be referred to as an idle mode or deactivated mode), and the method 300 comprises: responsive to receiving the wake-up signal, exiting the power saving mode. Exiting the power saving mode may also be regarded as activating 340 the network node. The network node may for example exit the power saving mode to transmit 330 the SSB. Exiting the power saving mode may for example comprise activating 340 one or more components and/or functions of the network node.

Further embodiments of the method 300 are provided throughout the present disclosure, for example in the section entitled “Group B Embodiments”.

Some example embodiments are as follows.

Embodiment 1. A method of a UE configured to receive an SSB-like, or lightweight SSB (LWS) or a discovery reference signal (DRS), where the said signal (from hereon called DRS) occupies a lower number of time/frequency (T/F) resources, e.g., a lower number of symbols or resource elements (REs) than the normal SSB, and includes at least one of the PSS or SSS or a modified version of them and/or of the PBCH/MIB. Additionally, the UE may decide to transmit a WUS in response to receiving a DRS.

Embodiment 2. As Embodiment 1, wherein the DRS MIB is a lightweight version of normal PBCH/MIB, where the number of PBCH symbols or REs is reduced and/or one or more components of the normal MIB is not present in the MIB of the DRS. The PBCH/MIB of the DRS may for example be modified in one or more of the following ways:
The modified/reduced PBCH may comprise a shorter payload field, different coding scheme, different cyclic redundancy check (CRC) length, different demodulation reference signal (DMRS) configuration, etc. compared to normal PBCH.
The MIB contents comprise one or more changes compared to the MIB in Rel-15:
   1. One or more of the currently defined parameters {cellBarred, intraFreqReselection, pdcch-ConfigSIB1, . . . } may be missing or modified.
   2. One or more of the following may be added:
      1. pdcch-ConfigSIB-new e.g., pointing at resources in another cell where the SIB1 for this cell can be fetched.
      2. Wakeup Signal (WUS) configuration, or a configuration index or a WUS resource (e.g. an uplink wakeup signal preamble index, etc).
      3. Anchor cell (e.g. cell providing information on behalf of this cell) information/indication (for example a physical cell ID for the anchor cell).
      4. A system information value tag (For example a hash/code that changes when a change occurs in any SI contents. A UE that has previously received the SI can check whether there have been changes since last time. If not, it does not need to re-read the SI).

Embodiment 3. An any of embodiments 1-2, wherein at least one of the T/F/spatial resources of the DRS is different compared to a for normal SSB, e.g., one or more of:
a DRS can have a different periodicity than an SSB, e.g., the UE may expect a longer periodicity such as 40 ms, 80 ms or even higher than 160 ms, such as 340 ms or 680 ms,
A DRS can have a periodic burst, e.g., every 640 ms, a specific number of DRSs may be transmitted with a periodicity of 20 ms, e.g., 5 DRSs.
A DRS can be packed in time resources while SSB signals cannot be packed in a row in time and only 2 SSBs are allowed per slot.
The DRS may be transmitted in different T/F resources compared to the SSB raster.

Embodiment 4. Any of embodiments 1-3, wherein the PSS and/or SSS is modified, where the modification may comprise a different sequence compared to Rel-15, a lower number of REs/PRBs (physical resource blocks) utilized, etc.

Embodiment 5. Any of embodiments 1-4, wherein the UE receives a modified version of PSS and recognizes that this is a DRS and not an SSB.

Embodiment 6. Any of embodiments 1-5, wherein the DRS only occupies one symbol, e.g., only a PSS or a modified PSS; or only a SSS and a modified SSS, or a combination of options, e.g., a PSS and a SSS or a modified version in a frequency-multiplexed configuration.
The UE recognizes the modified SSB based on not detecting a corresponding SSS or PSS, respectively, or based on not decoding a corresponding PBCH, e.g., when DRS is configured where SSB would have been, e.g., overlapping T/F resources with a PSS.

Embodiment 7. Any of embodiments 1-6, wherein the DRS occupies at least two symbols, wherein one example PSS and SSS or modified versions of them are located in different symbols compared to legacy PSS/SSS symbols from for example Rel 15.
The UE may perform tentative reception with legacy and DRS symbol assumptions to determine whether the received signal is a DRS.

Embodiment 8. Any of embodiments 1-7, wherein the MIB of the DRS is located around a SSS or its modified version, e.g., the UE is configured with a PSS and a SSS as reference signals (RSs) in DRS, and PSS is in the first symbol while SSS is in the second one and then MIB is configured around SSS in the frequency domain.

Embodiment 9. Any of embodiments 1-8, wherein the UE is configured with a MIB around the PSS or both PSS and SSS or modified versions of them.

Embodiment 10. Any of embodiments 1-9, wherein the UE is configured with a 3 symbol DRS (or normal SSB size—1 symbol) and MIB occupies at least one symbol of its own.

Certain embodiments may provide one or more of the following technical advantage(s). The present disclosure provides methods and mechanisms with which a second gNB which the UE is camping on can go to longer sleep (e.g. deeper sleep modes than micro sleep) if there is nothing to be transmitted because the second gNB is not required to transmit one or more of SSB/SIB1/MIB or other SIBs frequently. Instead, either a first gNB (e.g., with overlapping cells) transmit these signals, or the second gNB can be woken up by the UE to provide necessary information. The second gNB can transmit discovery signals based on which the UEs can detect the second gNB, and based on which the UEs know how to act in the second gNB. The ability of the second gNB to go to longer and/or deeper sleep allows the second gNB to save energy.

### Additional Explanation

The present disclosure describes the characteristics of an SSB-like or lightweight SSB (LWS), also referred to herein as a discovery reference signal (DRS). Compared to the Rel-15 SSB, the DRS may occupy a lower number of T/F resources, e.g., a lower number of symbols or resource elements (REs) than the normal SSB, and may include at least one of the normal PSS or SSS, or a modified version of the PSS or SSS and/or of the PBCH/MIB.

Here, particularly a scenario is considered where the DRS is typically transmitted from a deactivated cell or a cell which has stopped transmitting legacy SSBs or does not transmit legacy SSBs. The UE then discovers the DRS, and may additionally be configured with the information from the DRS, or from a light weight SIB1 or from a normal SIB1 transmitted from the same cell or from another cell, where to transmit a WUS. The UE then transmits a WUS over configured T/F resources. In response to the WUS, the cell can become active (for example the cell can start transmission of legacy SSBs and potentially SIB1) and thus the UE can start getting access to the cell, e.g., to establish a connection.

### Modifications to Physical Structure

In one aspect, the T/F/spatial resources of the DRS are different from a normal SSB. For example, one or more of the beams associated with DRS can be different from the normal SSB, In another example, a DRS can have a different periodicity than an SSB. A DRS can be packed in time resources while SSB signals cannot be packed in a row in time and only 2 SSBs are allowed per slot. In another example, the DRS is transmitted in different T/F resources compared to the SSB raster. DRS can be also configured to be provided based on a duty cycle (for example, every 640 ms, a specific number of DRSs, for example 5 DRSs, are transmitted with a periodicity of 20 ms). Other examples are not excluded.

In one aspect, a PSS and/or SSS used in the DRS is modified, where the modification may comprise, a different sequence compared to Rel-15, a lower number of REs/PRBs utilized, etc. For example, the UE may receive a modified version of PSS and may recognize that this is a DRS and not an SSB.

In one aspect, the DRS only occupies one symbol, e.g., only a PSS or a modified version of Rel-15 PSS, or only an SSS and/or a modified SSS, or a combination of options, e.g., a PSS and a SSS or a modified version in a frequency-multiplexed configuration.

In one aspect, the UE recognizes the modified SSB based on not detecting a corresponding Rel-15 SSS or PSS, respectively, or based on not decoding a corresponding PBCH. This may for example be performed in a scenario where DRSs are located at resources where SSBs otherwise would have been located F. For example, DRS may overlap with a PSS in T/F resources.

In one aspect, the DRS occupies at least two symbols. For example, PSS and SSS or modified versions of these may be located in different symbols compared to legacy PSS/SSS symbols. The UE may perform tentative reception with legacy and DRS symbol assumptions to determine whether the received signal is a DRS.

In one aspect, the MIB (or the new/modified version of it) is located around a SSS or a modified version of a SSS. For example, the UE may be configured with a PSS and a SSS as reference signals (RSs) in DRS, and the PSS may be located in the first symbol while the SSS may be located in the second one and then MIB is configured around SSS in the frequency domain.

In one aspect, the UE is configured with a MIB around the PSS or both PSS and SSS or modified versions of them.

In one aspect, the UE is configured with a 3 symbol DRS (or normal SSB size—1 symbol) and MIB occupies at least one symbol of its own.

In one aspect, the DRS includes a Master Information Block (MIB) which is a lightweight version of the NR PBCH/MIB (normal MIB) from for example Rel-15, where the number of PBCH symbols or REs is reduced and/or one or more components of the normal MIB is not present. Such reduction can for example be achieved by shorter payload field, different coding scheme, different CRC length, different DMRS configuration, etc.

### Modifications to Information Contents

In at least some embodiments where the DRS includes a new/modified MIB, the new MIB contents may comprise one or more changes compared to Rel-15 MIB (normal MIB), such as:
omitting one or more of the currently defined parameters (such as cellBarred, intraFreqReselection, pdcch-ConfigSIB1, . . . ), or currently provided beam index; and/or
adding one or more of:
   pdcch-ConfigSIB-new, e.g., pointing at resources in another cell where the SIB1 for this cell can be fetched.
   Wakeup Signal (WUS) configuration, or a configuration index. Rather than having a generic WUS that wakes up every gNB that receives/decodes a WUS, there may exist a bank/list/pool (several configurations) of distinguishable WUSs. Each WUS may be tied to a DRS. When a UE decodes a DRS and wants to wake up the gNB, the UE transmits a relevant WUS (out of several) that wakes up that specific gNB. This configuration may in one embodiment be optionally provided by the network (NW), for example by the gNB. In one embodiment, if the information is not present, then waking up of this gNB is not allowed.
   Anchor cell (cell providing information on behalf of this cell) information/indication. The information provided could be one or more of SSB, SIB1, other system information, or paging. For example, the information could be cell id of the cell providing the information. One thing a DRS could provide is to not associate to a broadcasted SIB1 (For example, normal SSB may have an association to (RMSI) SIB via a common search space configuration. But this may not be included for the DRS). If the PBCH would contain some kind of “Minimum SI identifier” then a UE that has received the minimum SI (e.g., SIB1 and perhaps also MIB) from a coverage cell could verify the validity of the minimum SI. That would avoid a “second sweep of SIB1” that would normally be required. The MIB in the lightweight SSB (or DRS) could also contain a pointer that helps the UE find the cell providing the minimum SI.
   The DRS could also be associated with a broader beam. A “sleeping cell” could then operate in “single SSB mode” which would reduce the number of SSB (and SIB and paging) transmissions by a factor of up to 64 times. In that case a different physical random access channel (PRACH) resource could be configured for the DRS compared to legacy SSB-PRACH mapping, and this new PRACH-like resource could for example be used for WUS transmission. And for “single SSB operation”, the cell might still transmit one instance of “SIB1” containing this configuration (such as a lightweight SIB1). To increase the DTX duration in “single SSB mode”, the DRS and the lightweight SIB1 (and perhaps also any potential paging) could be frequency multiplexed. The UE should be capable of maintaining connection to a cell as it switches from “single SSB mode” (using DRS and lightweight SIB1) to “multiple SSB mode” (using normal SSB and SIB1 transmissions).
   The lightweight SIB1 could be a new field in the “normal SIB1”. The normal SIB1 (with lightweight SIB1 added as a new field) could be provided to the connected UEs prior to a switch from “single SSB mode” to “multiple SSB mode”. The move from single SSB mode to multiple SSB mode can be initiated by the UE transmitting the WUS. In case the WUS is transmitted to the same cell, then the cell can start legacy or normal SSB mode or multiple SSB mode (e.g., if the cell was deactivated, it can become active).

For uplink wakeup signal, the UE may acquire one or more of the following information from a physical layer signal/channel (such as a lightweight SSB, DRS or a PBCH), or a higher layer signaling such as system information block.
Uplink frequency resource information, which may indicate the frequency domain resources, where a UE may transmit the uplink wakeup signal. Additional uplink preamble information, which may indicate preambles (or PRACH-preamble-like resource allocations) that a UE may be allowed to use for the uplink wakeup signal.
An uplink time offset which may indicate the time domain resources, where a UE may transmit the uplink wakeup signal. For example, the uplink wakeup signal may be transmitted X slots/symbols after the detection of/relative to a downlink (DL) signal such as the DRS.
Uplink response information which may indicate the response from a gNB to the detection of an uplink wakeup signal. For example, if the gNB successfully receives the WUS, the UE may expect a response (such as a physical downlink control channel (PDCCH), SSB, etc) in a time window relative to the transmission of the uplink WUS. For example, the gNB can explicitly configure the start and duration of the response window. In some cases, if a UE does not detect a response in a response window, it may assume the previous WUS transmission is unsuccessful, and the UE may attempt to transmit the WUS again. Subsequent to the response or WUS transmission, the UE may expect additional information such as SSB, SIBs, etc.
Uplink WUS subcarrier spacing (SCS) which may indicate the subcarrier spacing allowed for the transmission of uplink wakeup signal.
Uplink WUS sequence characteristics, e.g. cyclic shift, encoding (e.g. orthogonal cover code, OCC), etc.

### DRS Transmission Configurations

In one example, the DRS and lightweight SIB1 (used in single SSB operation) could then also be transmitted in single frequency (SFN) mode (e.g., multiple gNBs or TRPs transmitting the same signal) and that could significantly increase the signal-to-interference-plus-noise ratio (SINR) on the reception of the minimum SI (such as the MIB and/or the SIB1).

For example, with some geometry calculations for a 2 GHz carrier, the SINR increase for 500 m inter-site distance (ISD) was about 25 dB. This comes from the fact that all interference is now signal, and the only thing left is thermal noise (since neighbor cells transmit the same signal, it combines over the air and contributes to desired signal reception.). You get a small power gain (about 3-4 dB), but most of this gain comes from reduced interference when you transmit in SFN mode. This extra SINR could then be used to transmit the DRS and lightweight SIB1 from a limited number of antenna elements. You don't need +25 dB extra SINR on the DRS and lightweight SIB1, so you can start to turn off antenna elements. If you normally use all 64 antenna elements to transmit the normal SSB and SIB1, you might only need between 2 to 8 transmit (TX) antennas for a DRS and lightweight SIB1 when you know that this is transmitted in SFN mode.

How many antenna elements that are needed to transmit an SSB should be configurable. In this case, a “power delta” parameter can be introduced that indicates to the UE how much extra power a “normal SSB” can be expected to have.

In some embodiments, a DRS could be to only PSS and SSS. In this case, in one example, the DRS can be transmitted in a single OFDM symbol. The problem with this is then that the UE will not know the beam index (which is required to do a proper PRACH transmission. Therefore, an explicit beam identifier can be added so that the DRS contains the PSS and SSS (i.e. timing and physical cell identity, PCI) as well as a BeamIndex (which can be encoded with an additional sequence, or the SSS can be modified to also encode the BeamIndex). Alternatively, the PRACH procedure could be made independent of the beam index (only relative time/frequency offset for the PRACH resource would then be possible).

### Further Embodiments

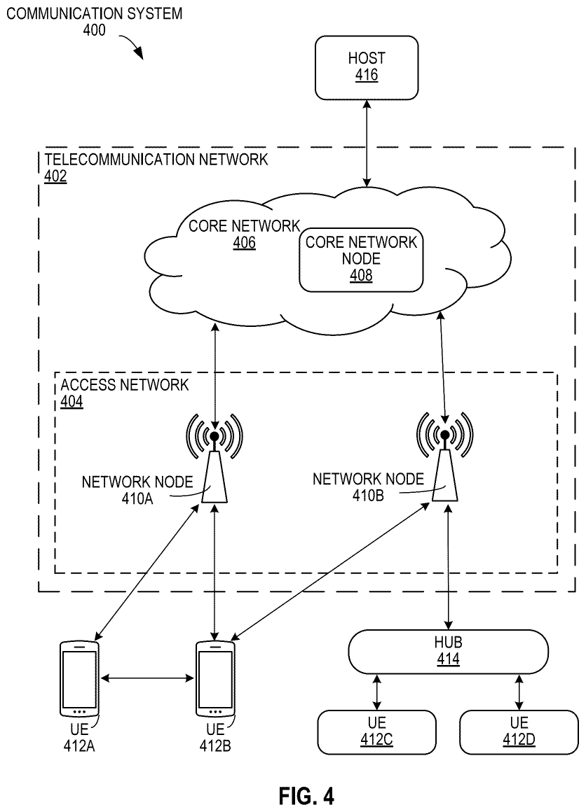

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio —Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

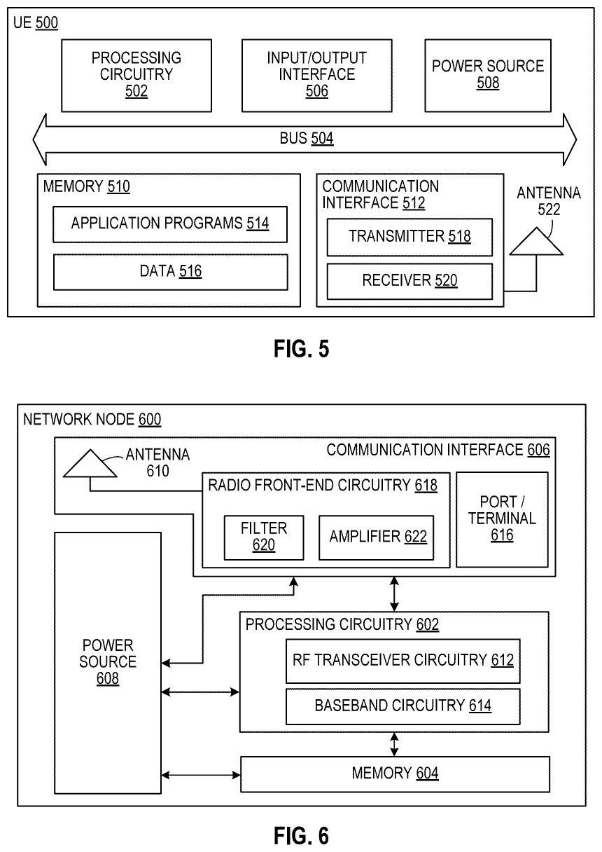

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE. The “term wireless communication device” is also used in some places of this disclosure to denote devices such as UEs.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

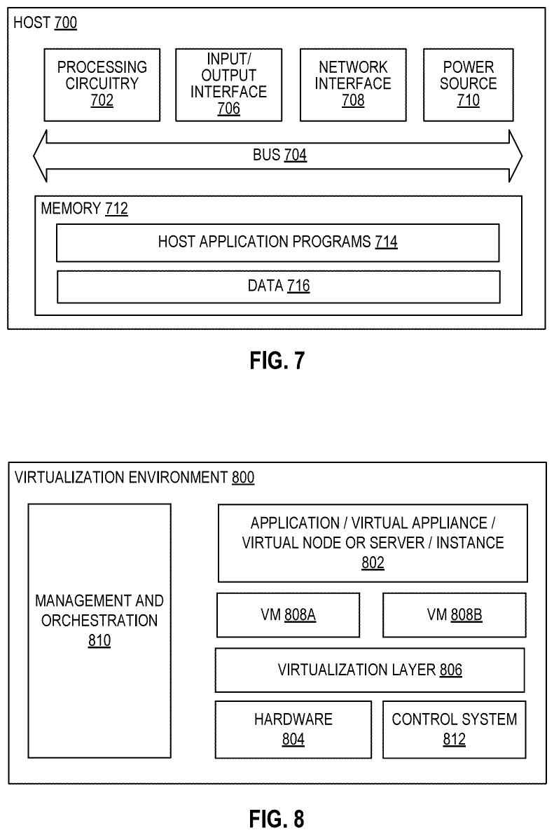

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

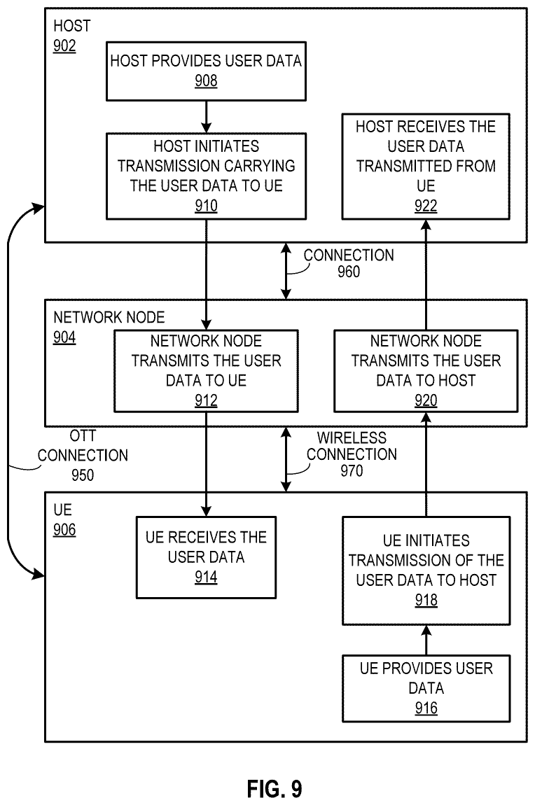

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may reduce power consumption of network nodes 904, and thereby provide benefits such as reduced power consumption of the overall communication system.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method (200) performed by a wireless communication device, the method comprising:
   receiving (210) a discovery signal.
2. The method of any of the preceding group A embodiments, wherein the discovery signal occupies less time and/or frequency resources than a synchronization signal bock, SSB, specified in NR Release 15.
3. The method of any of the preceding group A embodiments, wherein the discovery signal occupies less than four symbols in a time domain.
4. The method of any of the preceding group A embodiments, wherein the discovery signal occupies less than four orthogonal frequency-division multiplexing, OFDM, symbols.
5. The method of any of the preceding group A embodiments, wherein the discovery signal occupies less than 20 physical resource blocks, PRBs, in a frequency domain.
6. The method of any of the preceding group A embodiments, further comprising:
   responsive to receiving the discovery signal, transmitting (220) a wake-up signal.
7. The method of the preceding embodiment, wherein the discovery signal indicates:
   which wake-up signal to transmit; and/or
   in which time and/or frequency resources to transmit the wake-up signal.
8. The method of any of the two preceding embodiments, further comprising:
   receiving (230) a synchronization signal block, SSB, after transmitting the wake-up signal.
9. The method of any of the three preceding embodiments, wherein the discovery signal indicates:
   in which time and/or frequency resources to receive a signal (for example a SSB or a PDCCH) indicating receipt of the wake-up signal at a network node.
10. The method of any of the preceding group A embodiments, wherein the discovery signal is received from a first cell, and wherein the discovery signal indicates a second cell from which the wireless communication device can obtain:
   a synchronization signal block, SSB; and/or
   a master information block, MIB; and/or
   a system information block 1, SIB1.
11. The method of any of the preceding group A embodiments, wherein the discovery signal is received from a first cell, and wherein the discovery signal indicates time and/or frequency resources in a second cell from which the wireless communication device can obtain:
   a synchronization signal block, SSB; and/or
   a master information block, MIB; and/or
   a system information block 1, SIB1.
12. The method of any of the preceding group A embodiments, wherein the discovery signal is received from a first cell, and wherein the discovery signal comprises an identifier, wherein the method further comprises using the identifier to verify validity of:
   a synchronization signal block, SSB received from a second cell; and/or
   a master information block, MIB, received from a second cell; and/or
   a system information block 1, SIB1, received from a second cell.
13. The method of any of the preceding group A embodiments, wherein the discovery signal comprises:
   a primary synchronization signal; and/or
   a secondary synchronization signal; and/or
   a physical broadcast channel; and/or
   a master information block.
14. The method of any of the preceding group A embodiments, wherein the discovery signal comprises a primary synchronization signal that:
   occupies less time and/or frequency resources than a primary synchronization signal, PSS, specified in NR Release 15; and/or
   is based on a different sequence than a primary synchronization signal, PSS, specified in NR Release 15; and/or
   is located at different time and/or frequency resources than a primary synchronization signal, PSS, specified in NR Release 15.
15. The method of any of the preceding group A embodiments, wherein the discovery signal comprises a secondary synchronization signal that:
   occupies less time and/or frequency resources than a secondary synchronization signal, SSS, specified in NR Release 15; and/or
   is based on a different sequence than a secondary synchronization signal, SSS, specified in NR Release 15; and/or
   is located at different time and/or frequency resources than a secondary synchronization signal, SSS, specified in NR Release 15.
16. The method of any of the preceding group A embodiments, wherein the discovery signal comprises a master information block that:
   occupies less time and/or frequency resources than a master information block, MIB, specified in NR Release 15; and/or
   is located at different time and/or frequency resources than a master information block, MIB, specified in NR Release 15; and/or
   lacks at least one part/portion/field/parameter of a master information block, MIB, specified in NR Release 15; and/or
   has a modified version of at least one part/portion/field/parameter of a master information block, MIB, specified in NR Release 15.
17. The method of any of the preceding group A embodiments, wherein the discovery signal comprises a physical broadcast channel that:
   occupies less time and/or frequency resources than a physical broadcast channel, PBCH, specified in NR Release 15; and/or
   is located at different time and/or frequency resources than a physical broadcast channel, PBCH, specified in NR Release 15; and/or
   uses a different coding scheme, a different cyclic redundancy check length, a different demodulation reference signal configuration than a physical broadcast channel, PBCH, specified in NR Release 15.
18. The method of any of the preceding group A embodiments, further comprising:
   providing user data; and
   forwarding the user data to a host via the transmission to the network node.

### Group B Embodiments

1. A method (300) performed by a network node, the method comprising:
   transmitting (310) a discovery signal.
2. The method of any of the preceding group B embodiments, wherein the discovery signal occupies less time and/or frequency resources than a synchronization signal bock, SSB, specified in NR Release 15.
3. The method of any of the preceding group B embodiments, wherein the discovery signal occupies less than four symbols in a time domain.
4. The method of any of the preceding group B embodiments, wherein the discovery signal occupies less than four orthogonal frequency-division multiplexing, OFDM, symbols.
5. The method of any of the preceding group B embodiments, wherein the discovery signal occupies less than 20 physical resource blocks, PRBs, in a frequency domain.
6. The method of any of the preceding group B embodiments, further comprising:
   receiving (320) a wake-up signal after transmitting the discovery signal.
7. The method of the preceding embodiment, wherein the discovery signal indicates:
   which wake-up signal to be transmitted by a wireless communication device; and/or
   in which time and/or frequency resources a wireless communication device is to transmit the wake-up signal.
8. The method of any of the two preceding embodiments, further comprising:
   responsive to receiving the wake-up signal, transmitting (330) a synchronization signal block, SSB.
9. The method of any of the three preceding embodiments, wherein the discovery signal indicates:
   in which time and/or frequency resources a signal (for example a SSB or a PDCCH) indicating receipt of the wake-up signal at the network node will be transmitted.
10. The method of the preceding embodiment, comprising:
   responsive to receiving the wake-up signal, transmitting (330) said signal in the time and/or frequency resources indicated by the discovery signal.
11. The method of any of the five preceding embodiments, wherein the discovery signal is transmitted with a first periodicity (the discovery signal may for example be transmitted every X ms during some time duration), the method comprising:
   responsive to receiving the wake-up signal, transmitting (330) a synchronization signal block, SSB, with a second periodicity which is shorter than the first periodicity (the SSB may for example be transmitted every Y ms during some time duration, where Y is smaller than X).
12. The method of any of the six preceding embodiments, wherein the discovery signal is transmitted while the network node is in a power saving mode (which may for example be referred to as an idle or deactivated mode), the method further comprising:
   responsive to receiving the wake-up signal, exiting (340) the power saving mode.
13. The method of any of the seven preceding embodiments, comprising:
   responsive to receiving the wake-up signal, activating (340) a component and/or function of the network node.
14. The method of any of the preceding group B embodiments, wherein the discovery signal is transmitted while the network node is in a power saving mode (which may for example be referred to as an idle or deactivated mode).
15. The method of any of the preceding group B embodiments, wherein the discovery signal is transmitted in a first cell, and wherein the discovery signal indicates a second cell from which a wireless communication device can obtain:
   a synchronization signal block, SSB; and/or
   a master information block, MIB; and/or
   a system information block 1, SIB1.
16. The method of any of the preceding group B embodiments, wherein the discovery signal is transmitted in a first cell, and wherein the discovery signal indicates time and/or frequency resources in a second cell from which a wireless communication device can obtain:
   a synchronization signal block, SSB; and/or
   a master information block, MIB; and/or
   a system information block 1, SIB1.
17. The method of any of the preceding group B embodiments, wherein the discovery signal is transmitted in a first cell, and wherein the discovery signal comprises an identifier for verifying validity of:
   a synchronization signal block, SSB received from a second cell; and/or
   a master information block, MIB, received from a second cell; and/or
   a system information block 1, SIB1, received from a second cell.
18. The method of any of the preceding group B embodiments, wherein the discovery signal comprises:
   a primary synchronization signal; and/or
   a secondary synchronization signal; and/or
   a physical broadcast channel; and/or
   a master information block.
19. The method of any of the preceding group B embodiments, wherein the discovery signal comprises a primary synchronization signal that:
   occupies less time and/or frequency resources than a primary synchronization signal, PSS, specified in NR Release 15; and/or
   is based on a different sequence than a primary synchronization signal, PSS, specified in NR Release 15; and/or
   is located at different time and/or frequency resources than a primary synchronization signal, PSS, specified in NR Release 15.
20. The method of any of the preceding group B embodiments, wherein the discovery signal comprises a secondary synchronization signal that:
   occupies less time and/or frequency resources than a secondary synchronization signal, SSS, specified in NR Release 15; and/or
   is based on a different sequence than a secondary synchronization signal, SSS, specified in NR Release 15; and/or
   is located at different time and/or frequency resources than a secondary synchronization signal, SSS, specified in NR Release 15.
21. The method of any of the preceding group B embodiments, wherein the discovery signal comprises a master information block that:
   occupies less time and/or frequency resources than a master information block, MIB, specified in NR Release 15; and/or
   is located at different time and/or frequency resources than a master information block, MIB, specified in NR Release 15; and/or
   lacks at least one part/portion/field/parameter of a master information block, MIB, specified in NR Release 15; and/or
   has a modified version of at least one part/portion/field/parameter of a master information block, MIB, specified in NR Release 15.
22. The method of any of the preceding group B embodiments, wherein the discovery signal comprises a physical broadcast channel that:
   occupies less time and/or frequency resources than a physical broadcast channel, PBCH, specified in NR Release 15; and/or
   is located at different time and/or frequency resources than a physical broadcast channel, PBCH, specified in NR Release 15; and/or
   uses a different coding scheme, a different cyclic redundancy check length, a different demodulation reference signal configuration than a physical broadcast channel, PBCH, specified in NR Release 15.
23. The method of any of the preceding group B embodiments, further comprising:
   obtaining user data; and
   forwarding the user data to a host or a user equipment or a wireless communication device.

### Group C Embodiments

1. A user equipment (UE) or wireless communication device configured to perform the method of any of the Group A embodiments.
2. A network node configured to perform the method of any of the Group B embodiments. 3-6. -
7. A user equipment or wireless communication device comprising:
   processing circuitry configured to perform any of the steps of any of the Group A embodiments; and
   power supply circuitry configured to supply power to the processing circuitry.
8. A network node comprising:
   processing circuitry configured to perform any of the steps of any of the Group B embodiments;
   power supply circuitry configured to supply power to the processing circuitry.
9. A user equipment (UE) or wireless communication device comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE or wireless communication device to be processed by the processing circuitry;
   an output interface connected to the processing circuitry and configured to output information from the UE or wireless communication device that has been processed by the processing circuitry; and
   a battery connected to the processing circuitry and configured to supply power to the UE or wireless communication device.
10. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE) or wireless communication device, the network node having a communication interface and processing circuitry, the processing circuitry of the network node configured to perform any of the operations of any of the Group B embodiments to transmit the user data from the host to the UE or wireless communication device.
11. The host of the previous embodiment, wherein:
   the processing circuitry of the host is configured to execute a host application that provides the user data; and
   the UE or wireless communication device comprises processing circuitry configured to execute a client application associated with the host application to receive the transmission of user data from the host.
12. A method implemented in a host configured to operate in a communication system that further includes a network node and a user equipment (UE) or wireless communication device, the method comprising:
   providing user data for the UE or wireless communication device; and
   initiating a transmission carrying the user data to the UE or wireless communication device via a cellular network comprising the network node, wherein the network node performs any of the operations of any of the Group B embodiments to transmit the user data from the host to the UE or wireless communication device.
13. The method of the previous embodiment, further comprising, at the network node, transmitting the user data provided by the host for the UE or wireless communication device.
14. The method of any of the previous 2 embodiments, wherein the user data is provided at the host by executing a host application that interacts with a client application executing on the UE or wireless communication device, the client application being associated with the host application.
15. A communication system configured to provide an over-the-top (OTT) service, the communication system comprising:
   a host comprising:
   processing circuitry configured to provide user data for a user equipment (UE) or wireless communication device, the user data being associated with the over-the-top service; and
   a network interface configured to initiate transmission of the user data toward a cellular network node for transmission to the UE or wireless communication device, the network node having a communication interface and processing circuitry, the processing circuitry of the network node configured to perform any of the operations of any of the Group B embodiments to transmit the user data from the host to the UE or wireless communication device.
16. The communication system of the previous embodiment, further comprising:
   the network node; and/or
   the UE or wireless communication device.
17. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) or wireless communication device for the host.
18. The host of the previous 2 embodiments, wherein:
   the processing circuitry of the host is configured to execute a host application that receives the user data; and
   the host application is configured to interact with a client application executing on the UE or wireless communication device, the client application being associated with the host application.
19. The host of the any of the previous 2 embodiments, wherein the initiating receipt of the user data comprises requesting the user data.
20. A method implemented by a host configured to operate in a communication system that further includes a network node and a user equipment (UE) or wireless communication device, the method comprising:
   at the host, initiating receipt of user data from the UE or wireless communication device, the user data originating from a transmission which the network node has received from the UE or wireless communication device, wherein the network node performs any of the steps of any of the Group B embodiments to receive the user data from the UE or wireless communication device for the host.
21. The method of the previous embodiment, further comprising at the network node, transmitting the received user data to the host.
22. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE) or wireless communication device, wherein the UE or wireless communication device comprises a communication interface and processing circuitry, the communication interface and processing circuitry of the UE or wireless communication device being configured to perform any of the operations of any of the Group A embodiments to receive the user data from the host.
23. The host of the previous embodiment, wherein the cellular network further includes a network node configured to communicate with the UE or wireless communication device to transmit the user data to the UE or wireless communication device from the host.
24. The host of the previous 2 embodiments, wherein:
   the processing circuitry of the host is configured to execute a host application, thereby providing the user data; and
   the host application is configured to interact with a client application executing on the UE or wireless communication device, the client application being associated with the host application.
25. A method implemented by a host operating in a communication system that further includes a network node and a user equipment (UE) or wireless communication device, the method comprising:
   providing user data for the UE or wireless communication device; and
   initiating a transmission carrying the user data to the UE or wireless communication device via a cellular network comprising the network node, wherein the UE or wireless communication device performs any of the operations of any of the Group A embodiments to receive the user data from the host.
26. The method of the previous embodiment, further comprising:
   at the host, executing a host application associated with a client application executing on the UE or wireless communication device to receive the user data from the host application.
27. The method of the previous embodiment, further comprising:
   at the host, transmitting input data to the client application executing on the UE or wireless communication device, the input data being provided by executing the host application,
   wherein the user data is provided by the client application in response to the input data from the host application.
28. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE) or wireless communication device, wherein the UE or wireless communication device comprises a communication interface and processing circuitry, the communication interface and processing circuitry of the UE or wireless communication device being configured to perform any of the steps of any of the Group A embodiments to transmit the user data to the host.
29. The host of the previous embodiment, wherein the cellular network further includes a
   network node configured to communicate with the UE or wireless communication device to transmit the user data from the UE or wireless communication device to the host.
30. The host of the previous 2 embodiments, wherein:
   the processing circuitry of the host is configured to execute a host application, thereby providing the user data; and
   the host application is configured to interact with a client application executing on the UE, the client application being associated with the host application.
31. A method implemented by a host configured to operate in a communication system that further includes a network node and a user equipment (UE) or wireless communication device, the method comprising:
   at the host, receiving user data transmitted to the host via the network node by the UE or wireless communication device, wherein the UE or wireless communication device performs any of the steps of any of the Group A embodiments to transmit the user data to the host.
32. The method of the previous embodiment, further comprising:
   at the host, executing a host application associated with a client application executing on the UE or wireless communication device to receive the user data from the UE or wireless communication device.
33. The method of the previous 2 embodiments, further comprising:
   at the host, transmitting input data to the client application executing on the UE or wireless communication device, the input data being provided by executing the host application,
   wherein the user data is provided by the client application in response to the input data from the host application.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the |
| | power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single Frequency |
| | Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1.-33. (canceled)

34. A method performed by a wireless communication device, the method comprising:
receiving a discovery signal from a first cell, the discovery signal indicating a second cell from which the wireless communication device can receive system information;
receiving system information from the second cell, wherein the received system information indicates in which time and/or frequency resources to transmit a wake-up signal for waking up the first cell; and
transmitting the wake-up signal in the indicated time and/or frequency resources for waking up the first cell.

35. The method of claim 34, wherein the received system information is provided in a new system information block, SIB, compared to NR release 17.

36. The method of claim 34, wherein the discovery signal indicates time and/or frequency resources in the second cell from which the wireless device can obtain the system information.

37. The method of any claim 34, wherein the discovery signal occupies less time and/or frequency resources than a synchronization signal block, SSB, specified in NR Release 15.

38. The method of claim 34, wherein the discovery signal occupies less than four orthogonal frequency-division multiplexing, OFDM, symbols.

39. The method of claim 34, wherein the discovery signal occupies less than 20 physical resource blocks, PRBs, in a frequency domain.

40. The method of claim 34, wherein the discovery signal indicates:
in which time and/or frequency resources to receive a signal indicating receipt of the wake-up signal at a network node.

41. The method of claim 34, wherein the discovery signal comprises:
a primary synchronization signal; and/or
a secondary synchronization signal; and/or
a physical broadcast channel; and/or
a master information block.

42. A method performed by a network node, the method comprising:
transmitting a discovery signal in a first cell, the discovery signal indicating a second cell from which a wireless communication device can receive system information, wherein the system information indicates to the wireless device in which time and/or frequency resources to transmit a wake-up signal for waking up the first cell; and
receiving the wake-up signal in the indicated time and/or frequency resources.

43. The method of claim 42, wherein the discovery signal indicates time and/or frequency resources in the second cell from which the wireless device can obtain the system information.

44. The method of claim 42, wherein the discovery signal occupies less time and/or frequency resources than a synchronization signal bock, SSB, specified in NR Release 15.

45. The method of claim 42, wherein the discovery signal occupies less than four orthogonal frequency-division multiplexing, OFDM, symbols.

46. The method of claim 42, wherein the discovery signal occupies less than 20 physical resource blocks, PRBs, in a frequency domain.

47. The method of claim 42, further comprising:
responsive to receiving the wake-up signal, transmitting a signal indicating receipt of the wake-up signal.

48. The method of claim 42, wherein the discovery signal indicates:
in which time and/or frequency resources a signal indicating receipt of the wake-up signal at the network node will be transmitted.

49. The method of claim 48, comprising:
responsive to receiving the wake-up signal, transmitting said signal in the time and/or frequency resources indicated by the discovery signal.

50. The method of claim 42, wherein the discovery signal is transmitted with a first periodicity, the method comprising:
responsive to receiving the wake-up signal, transmitting a synchronization signal block, SSB, with a second periodicity which is shorter than the first periodicity.

51. The method of claim 42, wherein the discovery signal is transmitted while the network node is in a power saving mode, the method further comprising:
responsive to receiving the wake-up signal, exiting the power saving mode.

52. A wireless communication device comprising:
processing circuitry configured to:
receive a discovery signal from a first cell, the discovery signal indicating a second cell from which the wireless communication device can receive system information;
receive system information from the second cell, wherein the received system information indicates in which time and/or frequency resources to transmit a wake-up signal for waking up the first cell;
transmit the wake-up signal in the indicated time and/or frequency resources for waking up the first cell; and
power supply circuitry configured to supply power to the processing circuitry.

53. A network node comprising:
processing circuitry configured to:
transmit a discovery signal in a first cell, the discovery signal indicating a second cell from which a wireless communication device can receive system information, wherein the system information indicates to the wireless device in which time and/or frequency resources to transmit a wake-up signal for waking up the first cell; and
receive the wake-up signal in the indicated time and/or frequency resources; and
power supply circuitry configured to supply power to the processing circuitry.
